(19) United States
(12) Patent Application Publication
(10) Pub. No.: US 2013/0019744 A1
(43) Pub. Date: Jan. 24, 2013

(54) TIMING DEVICE FOR INTERMITTENT VACUUM REGULATOR

(71) Applicant: Yuegang Hu, Shanghai (CN)

(72) Inventor: Yuegang Hu, Shanghai (CN)

(73) Assignee: GENTEC (SHANGHAI) CORPORATION, Shanghai (CN)

(21) Appl. No.: 13/187,298

(22) Filed: Jul. 20, 2011

(30) Foreign Application Priority Data
Jul. 19, 2011 (CN) 201110202110.2

(51) Int. Cl. F15B 9/10

(52) U.S. Cl. 91/369.4; 91/471

(57) ABSTRACT

A timing device for an intermittent vacuum regulator comprises a diaphragm assembly that includes a diaphragm housing, a return spring, and a diaphragm projecting at least partially out of the diaphragm housing. A piston rod is coupled to the diaphragm. A connecting rod comprising an upper free end coupled to the piston rod and a lower fixed end coupled to a valve pin is provided. A piston stop comprising a semicircular C-shaped portion on its front side and a semi-cylindrical portion on its back side is also provided, wherein the piston rod directly pushes and pulls the connecting rod, such that during an intermittent operation of the timing device to actuate a valve assembly, the upper free end of the connecting rod rotates about the valve pin but is being limited in a range of motion by the piston stop.

### FIELD OF THE INVENTION

The present invention relates to the field of medical devices. In particular, the present invention relates to a timing device used in an intermittent vacuum regulator.

### BACKGROUND OF THE INVENTION

A vacuum regulating device, also known as a vacuum regulator or a suction regulator, is commonly used in the medical field to control the flow of vacuum from a terminal outlet of a vacuum source. Various medical procedures, such as gastrointestinal drainage, use a vacuum source to collect fluids out of a patient's body. In a typical setup of a vacuum source in hospitals, a vacuum supply terminal in the wall of a patient's room is connected to a vacuum regulator to control the flow of vacuum pressure to be applied. The vacuum regulator is in turn connected to a liquid collection bottle or container that collects the fluids extracted from the patient's body. A tube is provided to the patient's body on one end and the liquid collection container on the other end. As vacuum is applied, the fluids extracted from the patient's body are collected in the liquid collection container.

Two types of vacuum regulators are currently available in the market: continuous and intermittent. In a continuous vacuum regulator, suction is always applied while the regulator controls the level of the vacuum force. On the other hand, in an intermittent vacuum regulator, suction is alternately switched “on” and “off” according to predetermined time intervals, allowing the vacuum source to automatically operate in definite cycles of vacuum and atmospheric pressure.

### BRIEF SUMMARY OF THE INVENTION

One aspect of the invention provides a timing device that is securely attached to a body module (an integrated flow channel module) of a suitable intermittent vacuum regulator. The suitable intermittent vacuum regulator to be used with the timing device generally comprises a cover, a vacuum gauge, a regulating module, a mode select switch, the timing device, the body module, an air buffer, and a vacuum relief.

In another aspect, the invention provides a timing device for an intermittent vacuum regulator comprising a diaphragm assembly that includes a diaphragm housing, a return spring, and a diaphragm projecting at least partially out of the diaphragm housing. A piston rod is coupled to the diaphragm. A connecting rod comprising an upper free end coupled to the piston rod and a lower fixed end coupled to a valve pin is provided. A piston stop comprising a semicircular C-shaped portion on its front side and a semi-cylindrical portion on its back side is also provided, wherein the piston rod directly pushes and pulls the connecting rod, such that during an intermittent operation of the timing device to actuate a valve assembly, the upper free end of the connecting rod rotates about the valve pin but is being limited in a range of motion by the piston stop.

### BRIEF DESCRIPTION OF THE DRAWINGS

FIG. 1 illustrates an exploded view of an intermittent vacuum regulator incorporating a timing device according to a preferred embodiment;

FIG. 2 illustrates a front view of the timing device shown in FIG. 1 according to a preferred embodiment;

FIG. 3 illustrates an angled front view of the timing device shown in FIG. 2 according to a preferred embodiment;

FIG. 4 illustrates an exploded view of the timing device shown in FIG. 2 according to a preferred embodiment;

FIG. 5 illustrates a close-up diagonal view of a piston stop of a diaphragm assembly shown in FIG. 2 according to a preferred embodiment;

FIG. 6 illustrates a cross-sectional top view of the piston stop of the diaphragm assembly shown in FIG. 5 according to a preferred embodiment;

FIG. 7 illustrates a diaphragm assembly shown in FIG. 2 in an “on” position according to a preferred embodiment; and

FIG. 8 illustrates the diaphragm assembly shown in FIG. 7 in an “off” position according to a preferred embodiment.

FIG. 9 illustrates a method of timing of a timing device of an intermittent vacuum regulator.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE INVENTION

As used throughout the specification, the terms “inward,” “inner,” ‘interior,” or “medial” refer to a location inside or a direction toward a diaphragm housing, whereas the terms “outward,” “outer,” “exterior,” or “lateral” refer to a location outside or a direction away from the diaphragm housing.

The principle of operation of a suitable intermittent vacuum regulator to be used with a timing device in the present invention is fully described in Hu, U.S. Publication No. US 2009/0082741, which is incorporated herein by reference.

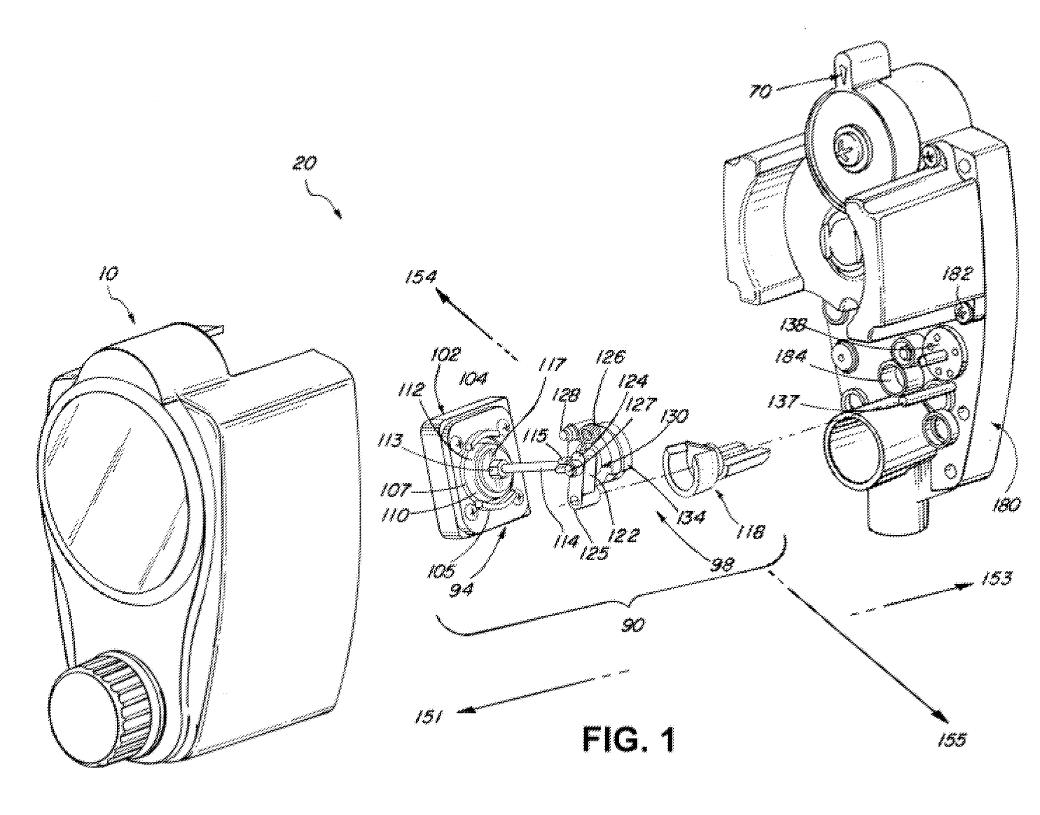

In FIG. 1, a preferred embodiment of a timing device is designated by a reference numeral 90. The timing device 90 is intended to be used with and incorporated in a suitable intermittent vacuum regulator 20 generally comprising a cover 10, a vacuum gauge (not shown), a regulating module (not shown), a mode select switch 70, the timing device 90, a body module (an integrated flow channel module) 180, an air buffer 182, and a vacuum relief 184. A valve seat 138 and a valve pin 137 are attached to the body module 180. As used throughout the specification, the terms “front” or “front side” 151 refers to a location or a direction toward the cover 10, whereas the term “rear” or “back side” 153 refers to a location or direction toward the body module 180. The regulator 20 also comprises a “left side” 154 and a “right side” 155.

As illustrated in FIG. 1, the timing device 90 comprises a diaphragm assembly 94 that includes a diaphragm housing 102, a return spring 106 (not shown in FIG. 1), and a diaphragm 110 protruding at least partially out of the diaphragm housing 102. A piston rod 114 is coupled to the diaphragm 110 and a connecting rod 122. A piston stop 118 is positioned adjacent to the connecting rod 122. A valve assembly 98 comprises a camshaft 128 coupled to a flywheel 130 and a valve plate 134. The timing device 90 further comprises a torsion spring 126 which toggles the valve assembly 98 either in a clockwise direction or counterclockwise direction. The diaphragm housing 102 is preferably rectangular, and includes a cover plate 103 on its lateral end having a circular opening 107, an upper shoulder 104 defining an upper edge of the circular opening 107, and a lower shoulder 105 defining a lower edge of the circular opening 107. The diaphragm 110 preferably comprises a flexible material such as rubber, and has a circular profile with an inner portion 111 (not shown in FIG. 1) and an outer portion 112. Preferably, the inner portion 111 has a larger diameter than the outer portion 112. Further, in the preferred embodiment, the inner portion 111 has a larger diameter than the circular opening 107, whereas the outer portion 112 has a smaller diameter than the circular opening 107 such that the outer potion 112 can protrude freely out of the diaphragm housing 102. The inner portion 111 is affixed to the inner circumference of the circular opening 107 to provide a vacuum seal. When the timing device 90 is in an “off” position as shown in FIG. 1, the outer portion 112 is being pulled out of the diaphragm housing 102 in the lateral direction by the piston rod 114, causing the outer portion 112 to substantially protrude out of the diaphragm housing 102.

The piston rod 114 preferably comprises a shaft with a hex shaped medial end 113 and a circular shaped lateral end 115. The connecting rod 122 comprises an elongated structure with a free end, or movable upper portion, 124 and a fixed end, or lower portion 125. The elongated structure may comprise elliptical front and back surface areas. The hex shaped medial end 113 of the piston rod 114 is connected to a washer 117 which is adjacently affixed to the center of the diaphragm 110, and the circular lateral end 115 of the piston rod 114 is connected to the upper portion 124 of the connecting rod 122. Both the upper portion 124 of the connecting rod 122 and the camshaft 128 of the valve assembly 98 are connected by the torsion spring 126. The valve pin 137 connects the lower portion 125 of the connecting rod 122 to the piston stop 118, which is configured to limit the range of the rotational motion of the connecting rod 122, and consequently the rotational range of the crank 127, the camshaft 128, the flywheel 130 and the valve plate 134.

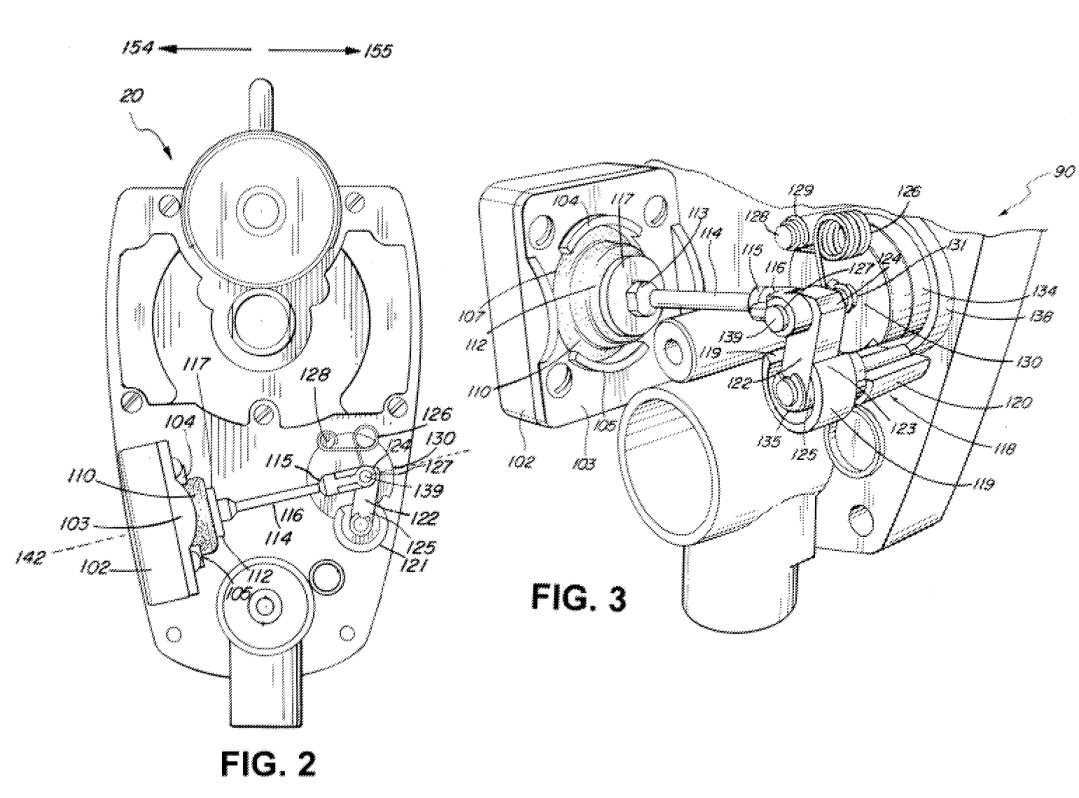

FIG. 2 illustrates the preferred timing device 90 incorporated in the intermittent vacuum regulator 20. The diaphragm housing 102, the diaphragm 110, the piston rod 114, and the connecting rod 122 are coupled to each other along a first axis 142. A crankpin 116 is configured to receive the circular shaped lateral end 115 of the piston rod 114 and connect the piston rod 114 to the connecting rod 122. At the other end, the washer 117 which is adjacently attached to the diaphragm 110 is configured to receive the hex shaped medial end 113 of the piston rod 114 and connect the piston rod 114 to the diaphragm 110. The torsion spring 126 connects the flywheel 130 at the camshaft 128 and the upper portion 124 of the connecting rod 122 at the crank 127. During the actual intermittent operation of the timing device 90, the connection point between the piston rod 114 and the connecting rod 122 at the crank 127 becomes a pivot point 139.

FIG. 2 further illustrates the preferred embodiment of the timing device 90 in an “off” position. In this “off” position, the outer portion 112 of the diaphragm 110 is being pulled out of the diaphragm housing 102 by the piston rod 114 in the lateral direction, causing the outer portion 112 to substantially protrude out of the diaphragm housing 102 and over the upper shoulder 104 and the lower shoulder 105 of the circular opening 107. From this front view of the timing device 90, and side view of the diaphragm housing 102 as shown in FIG. 2, it is to be expressly understood that the diaphragm housing 102 forms a chamber that enables the diaphragm 110 to be pulled into the diaphragm housing 102 as vacuum pressure is applied, or in an “on” position. This causes the piston rod 114 to actuate sideways in the medial direction along the axis 142, the connecting rod 122 to actuate rotationally in a counterclockwise direction, and the flywheel 130 and the valve plate 134 to actuate rotationally in a clockwise direction.

FIG. 3 is a perspective view the preferred embodiment of the timing device 90 as assembled. As shown, the timing device 90 is securely attached to a front part of the body module 180 of the intermittent vacuum regulator 20 when assembled. The flywheel 130 and the valve plate 134 are joined by the camshaft 128 and a center valve pin 140 (not shown in FIG. 3).

As such, during the actual operation, the flywheel 130 and the valve plate 134 rotate together as a unit. The torsion spring 126 provides a connection between the flywheel 130 and the connecting rod 122. The torsion spring 126 comprises a first loop 129 secured at the camshaft 128 on the flywheel 130 and a second loop 131 secured at the crank 127 on the upper portion 124 of the connecting rod 122. During the intermittent operation, the connection of the torsion spring 126 at the camshaft 128 and the crank 127 facilitates a simultaneous actuation of the piston rod 114, the flywheel 130 and the valve plate 134. As an example, and not by way of limitation, during the “on” mode, as vacuum pressure is applied and the diaphragm 110 is pulled into the diaphragm housing 102, the torsion spring 126, through the first loop 129 at the camshaft 128 and the second loop 131 at the crank 127, causes simultaneous sideways movement of the piston rod 114 in the medial direction, the rotational movement of the connecting rod 122 in the counterclockwise direction, and the rotational movement of the flywheel 130 and the valve plate 134 in the clockwise direction.

In the “off” position as illustrated in FIG. 3, the diaphragm housing 102 comprises the circular opening 107, defined by the upper shoulder 104 and the lower shoulder 105. The outer portion 112 of the diaphragm 110 is attached to the washer 117 and substantially pulled out of the circular opening 107. As the inner portion 111 (not shown in FIG. 3) of the diaphragm 110 is affixed to the inner circumference of the circular opening 107 and the outer portion 112 is being pulled out of the diaphragm housing 102, the diaphragm 110 exhibits an inverted bell profile.

As shown in FIG. 3, the hex shaped medial end 113 of the piston rod 114 is attached to the washer 117, whereas the circular shaped lateral end of the piston rod 114 is attached to the crankpin 116. The crankpin 116 provides the connection between the piston rod 114 and the upper portion 124 of the connecting rod 122 at the pivot point 139. The lower portion 125 of the connecting rod 122 is secured to the valve pin 137 with a first locking washer 135.

The piston stop 118 preferably comprises a C-shaped front portion 121 and a semi-cylindrical rear portion 120. The C-shaped portion 121 envelopes the lower portion 125 of the connecting rod 122 and further comprises a medial end 119, a lateral end 123, and a gap therebetween through which the connecting rod 122 moves. The medial end 119 provides a first stop for the rotation of the connecting rod 122 in the counterclockwise direction and the lateral end 123 provides a second stop for the rotation of the connecting rod 122 in the clockwise direction. The semi-cylindrical portion 120 provides linear support for the valve pin 137. The valve pin 137 is stationary, providing an axis for the connecting rod 122 to rotate.

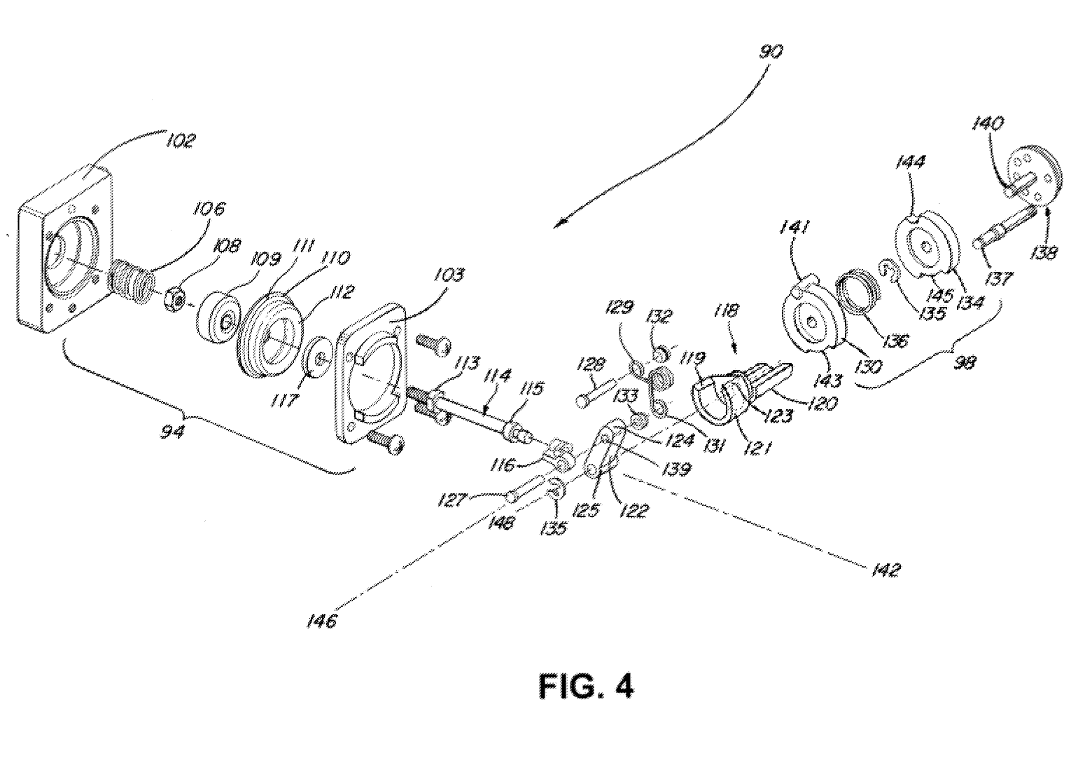

FIG. 4 illustrates an exploded view of the preferred timing device 90 according to a preferred embodiment. As seen here, the return spring 106 is placed within the diaphragm housing 102. FIG. 4 further illustrates how the inner portion 111 of the diaphragm 110 has a larger diameter than the diameter of the outer portion 112. A gasket 109 is provided on the inner portion 111 and the washer 117 is provided on the outer portion 112. The piston rod 114 is connected to the diaphragm 110 by inserting a threaded portion of the hex shaped medial end 113 through the washer 117, the diaphragm 110, and the gasket 109, and fastening it to a securing nut 108 on the inner side of the diaphragm 110. As the diaphragm 110 is composed of soft, flexible material such as rubber, the placement of the gasket 109 on the inner portion 111 and the washer 117 on the outer portion 112 provides a better vacuum seal to prevent atmospheric leakage and better mating surfaces between the return spring 106 and the gasket 109 on one end and between the gasket 109 and the washer 117 on the other end. Further, the return spring 106, the securing nut 108, the gasket 109, and the inner portion 111 are enclosed within the diaphragm housing 102. The components of the diaphragm assembly 94 are axially coupled to each other along the first axis 142.

Also illustrated in FIG. 4, the flywheel 130 further comprises a cylindrical slot 141 configured to receive the camshaft 128 and an indentation with a winged profile 143. The valve plate 134 further comprises a groove 144 configured to receive the slot 141, such that the slot 141 is snug fit in the groove 144 to enable the flywheel 130 and the valve plate 134 to rotate together as a unit. The valve plate 134 also comprises an indentation with a winged profile 145. A valve spring 136 is placed in between the flywheel 130 and the valve plate 134. The flywheel 130 and the valve plate 134 are configured such that the slot 141 is fitted in the groove 144, and the indentation 143 of the flywheel 130 is flush with the indentation 145 of the valve plate 134. The flywheel 130, the valve spring 136, and the valve plate 134 are axially coupled at the center valve pin 140 along a second axis 146, wherein a second locking washer 135 secures the connection at the front side of the center valve pin 140.

The valve pin 137 sits along the length the piston stop 118 through the semi-cylindrical portion 120 and the C-shaped portion 121, and passes through the lower portion 125 of the connecting rod 122. The first locking washer 135 secures the connection at the front side of the valve pin 137.

The crank 127 is configured to pass through the upper portion 124 of the connecting rod 122 and the second loop 131 of the torsion spring 126. The connection is then secured by a crank securing nut 133. The camshaft 128 is configured to pass through the first loop 129 of the torsion spring 126 and secured by a camshaft securing nut 132. The camshaft 128 is further inserted into the slot 141 of the flywheel 130. The torsion spring 126, through the first loop 129 at the camshaft 128 and the second loop 131 at the crank 127, causes simultaneous sideways movement of the piston rod 114 and the rotational movement of the flywheel 130 and the valve plate 134.

Also shown in FIG. 4, the crankpin 116 couples the piston rod 114 to the connecting rod 122. One end of the crankpin 116 is configured to receive a smooth portion of the lateral end 115 of the piston rod 114 and another end of the crankpin 116 is configured to receive the crank 127, such that the piston rod 114 is perpendicularly coupled to the connecting rod 122 through the crankpin 116 at the pivot point 139. The crankpin 116 holds the piston rod 114 and the connecting rod 122 together as the piston rod 114 moves sideways in a reciprocating piston stroke motion, or a “push-pull” motion, along the first axis 142 during the intermittent operation of the timing device 90.

The second axis 146 is a rotational axis of the flywheel 130 and the valve plate 134. A third axis 148 is a rotational axis of the connecting rod 122.

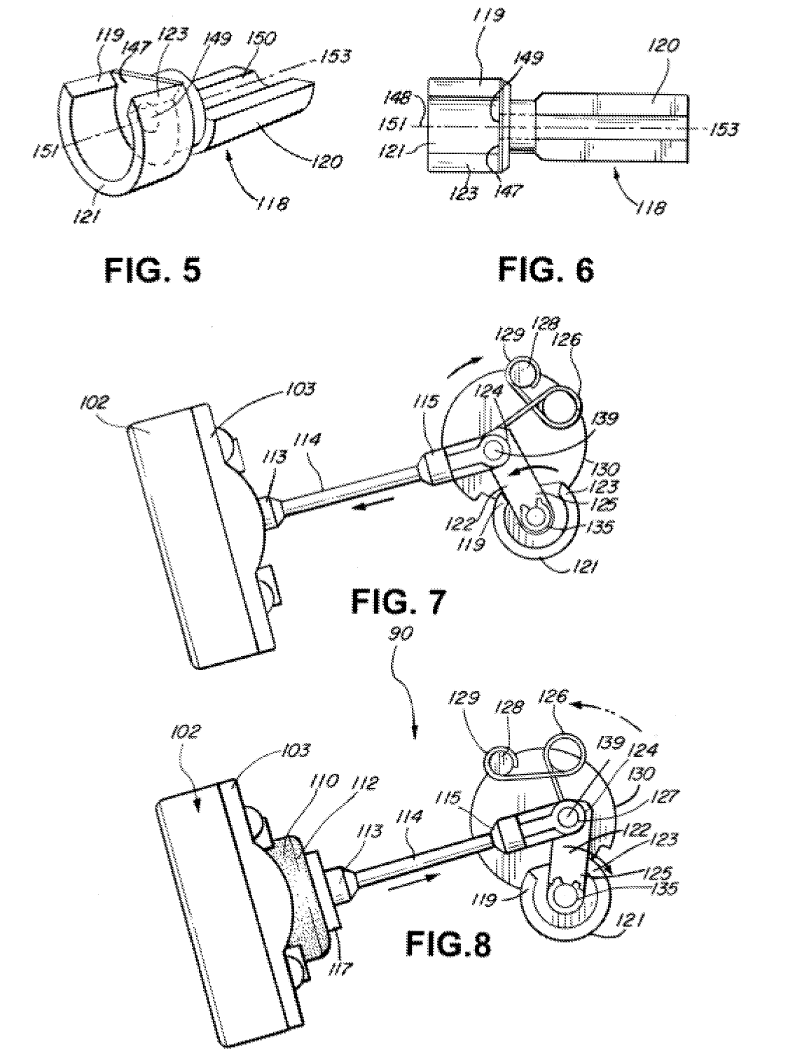

FIG. 5 illustrates a perspective close up view of the piston stop 118. In a preferred embodiment, the piston stop 118 has the semicircular, inverted “horse shoe” or C-shaped portion 121 on its front side and the semi-cylindrical portion 120 on its back side. The C-shaped portion 121 and the semi-cylindrical portion 120 are segregated by a wall 147, which defines a center hole 149 to allow the valve pin 137 to pass through along the third axis 148. The semi-cylindrical portion 120 has an elongated groove 150 configured to support the valve pin. In one preferred embodiment, the diameter of the semi-cylindrical portion 120 is smaller than the diameter of the C-shaped portion 121.

As shown in FIG. 5, the C-shaped portion 121 further comprises the medial end 119 and the lateral end 123. During the intermittent operation of the timing device 90, the connecting rod 122 rotates either in the counterclockwise direction about the third axis 148 as it is pulled by the piston rod 114 or in the clockwise direction as it is pushed by the piston rod 114. The medial end 119 limits the rotational range of the connecting rod 122 in the counterclockwise direction when pulled and the lateral end 123 limits the rotational range of the connecting rod 122 in the clockwise direction when pushed. Consequently, the sideways distance the piston rod 114 moves along the first axis 142 in the medial direction or the lateral direction is limited as well. This mechanism is particularly helpful, for example, in further preventing the diaphragm 110 from being completely pulled out of the diaphragm housing 102 by the piston rod 114 during the “off” cycle. It should be noted that in the preferred embodiment, the piston rod 114 does not move in a strictly linear fashion due to its direct pushing and pulling of the connecting rod 122, the movable end 124 of which travels in an arcuate path.

FIG. 6 illustrates a top cross-sectional view of the piston stop 118. As seen from the top, the C-shaped portion 121, which comprises the medial end 119 and the lateral end 123, preferably has a larger diameter than the semi-cylindrical portion 120. The wall 147 divides the C-shaped portion 121 and the semi-cylindrical portion 120. The semi-cylindrical portion 120 further comprises the elongated groove 150 with a uniform inner diameter, configured to allow the valve pin 137 to fit snugly along the length of the elongated groove 150.

Turning now to the operation of the timing device 90, FIG. 7 illustrates a preferred principle of operation of the timing device 90 during an “on” mode. In the beginning of the intermittent operation, the timing device 90 is in the “off” position as shown in FIG. 2. A vacuum source is provided to the vacuum regulator 20, regulated by a needle valve (not pictured) in the body module 180 and the air buffer 182 of the intermittent vacuum regulator 20 (See FIG. 1). The regulated vacuum pressure is subsequently applied to the diaphragm assembly 94 through the valve assembly 98.

As vacuum pressure is applied, the diaphragm 110 is being pulled axially along the first axis 142 in the medial direction against a lateral resistance of the return spring 106 inside the diaphragm housing 102 and the diaphragm 110. Consequently, the piston rod 114 begins to be gradually pulled in the medial direction. Since the piston rod 114 is connected to the crank 127 on the upper portion 124 of the connecting rod 122, the sideways movement of the piston rod 114 directly pulls the connecting rod 122 in the medial direction as well, thereby rotating the free end 124 of the connecting rod 122 counterclockwise. The connecting rod 122 and the flywheel 130 are connected by the torsion spring 126, wherein the torsion spring 126 has a certain rigidity that provides a rotational resistance. At one point, the simultaneous sideways movement of the piston rod 114 along the first axis 142 and the counterclockwise rotation of the connecting rod 122 about the third axis 148 reach a first critical position that overcomes both the lateral resistance of the return spring 106 and the rotational resistance of the torsion spring 126. At the same time, the medial end 119 of the piston stop 118 prevents the connecting rod 122 from rotating further.

At this first critical point, the flywheel 130 loses its stability under the action of the torsion spring 126. The torsion spring 126 then acts on the flywheel 130 to actuate both the flywheel 130 and the valve plate 134 to rotate clockwise rapidly as a unit about the second axis 146, thereby forcing flow channels of the body module 180 through the valve seat 138 to shift. The return spring 106 is compressed into the diaphragm housing 102, and the diaphragm 110 is collapsed and completely enclosed within the diaphragm housing 102. The vacuum operation starts and the timing device 90 is in the “on” mode. Vacuum pressure enters the regulating module 50 (not shown) and out through the outlet port of the vacuum regulator to the patient.

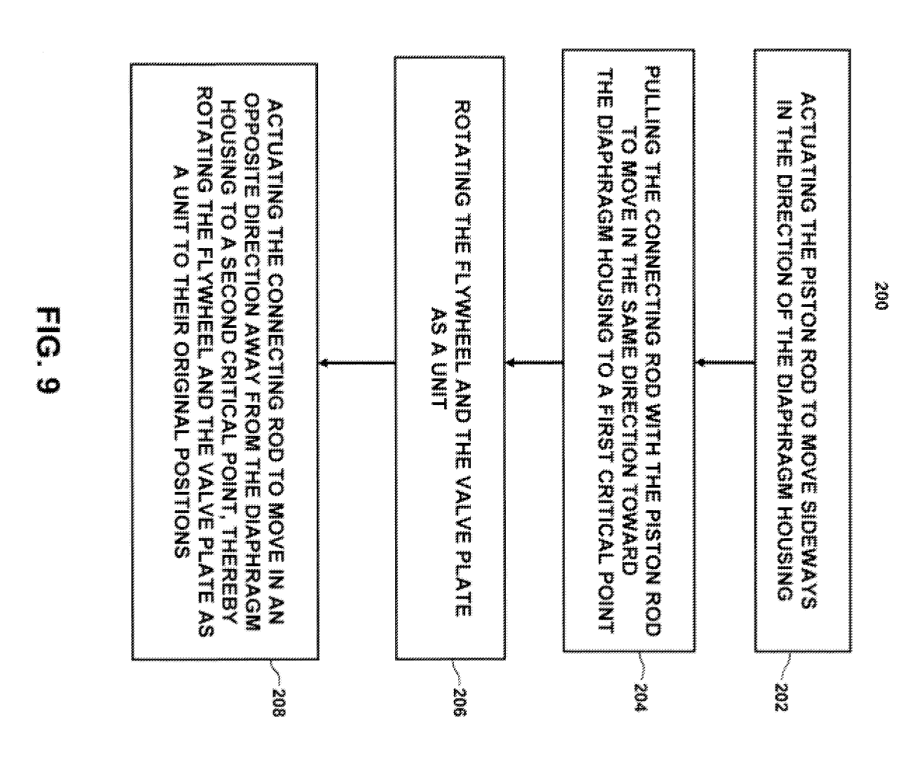

FIG. 8 illustrates the preferred principle of operation of the timing device 90 during an “off” mode. Subsequent to the “on” mode described above, under the resistance action of the return spring 106, the return spring 106 begins to decompress and return to its original state, causing the piston rod 114 to begin moving sideways along the first axis 142 in the lateral direction and the connecting rod 122 to begin rotating in the clockwise direction about the third axis 148. The lateral end 123 of the piston stop 118 prevents the connecting rod 122 from rotating further. At a second critical position, the flywheel 130 again loses its stability under the action of the torsion spring 126. The torsion spring 126 then acts on the flywheel 130 to actuate both the flywheel 130 and the valve plate 134 to rotate counterclockwise rapidly as a unit about the second axis 146, and return to their original positions. The flow channels of the body module 180 through the valve seat 138 are shifted back to their original status, the vacuum pressure is cut off, and the timing device is now back in the “off” position. The process described above is repeated during the intermittent operation of the timing device 90.

FIG. 9 illustrates a preferred method of timing 200 for a timing device in an intermittent vacuum regulator, wherein the timing device comprises a diaphragm housing enclosing a return spring, a diaphragm coupled to a piston rod, a connecting rod coupled to the piston rod on one end and a valve pin on the other end, and a flywheel coupled to a valve plate. In the method 200, step 202 comprises actuating the piston rod to move sideways in the direction toward the diaphragm housing. This step 202 may include applying vacuum pressure to gradually pull the diaphragm and the return spring in the direction of the diaphragm housing.

Step 204 comprises pulling the connecting rod with the piston rod to move in the same direction to a first critical point. This step 204 may include coupling the piston rod to a crank on a freely movable upper portion of the connecting rod and pulling the piston rod in the direction of the diaphragm housing until the resistance of the return spring is overcome.

Step 206 comprises rotating the flywheel and the valve plate as a unit. This step 206 may include coupling the crank on the upper portion of the connecting rod to a camshaft on the flywheel with a torsion spring, wherein the flywheel and the valve plate are connected together, moving the connecting rod about the valve pin in one direction toward the diaphragm housing until the resistance of the torsion spring is overcome, and rotating the flywheel and the valve plate together.

Step 208 comprises actuating the connecting rod to move in an opposite direction away from the diaphragm housing to a second critical point, thereby rotating the flywheel and the valve plate as a unit to their original positions. This step 208 may include gradually decompressing the return spring to its original state and actuating the piston rod to begin moving sideways in a direction away from the diaphragm housing.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what incorporates the essential idea of the invention.

What is claimed is:

1. A timing device for an intermittent vacuum regulator, comprising:
a diaphragm assembly comprising a diaphragm housing, a return spring, and a diaphragm projecting at least partially out of the diaphragm housing;
a piston rod comprising a first end and a second end, wherein the first end is coupled to the diaphragm;
a connecting rod comprising an upper free end coupled to the second end of the piston rod and a lower fixed end coupled to a valve pin; and
a piston stop comprising a semicircular C-shaped portion on its front side and a semi-cylindrical portion on its back side;
wherein the piston rod directly pushes and pulls the connecting rod, such that during an intermittent operation of the timing device, the upper free end of the connecting rod rotates about the valve pin but is being limited in a range of motion by the piston stop.

2. The timing device of claim 1, wherein the diaphragm is composed of a flexible material having a circular profile, and comprises an inner portion with a first diameter and an outer portion with a second diameter, wherein the first diameter is larger than the second diameter.

3. The timing device of claim 1, wherein:
the diaphragm housing further comprises a cover plate with a circular opening; and
the diaphragm further comprises an outer portion and an inner portion, wherein the inner portion has a larger diameter than the circular opening, the outer portion has a smaller diameter than the circular opening, and the inner portion is affixed to an inner circumference of the circular opening to provide a vacuum seal while the outer portion is substantially protruding out of the diaphragm housing.

4. The timing device of claim 1, further comprising a crankpin coupled to the piston rod and the connecting rod.

5. The timing device of claim 1, wherein:
the piston stop further comprises a wall with a center hole dividing the semi-circular C-shaped portion and the semi-cylindrical portion;
the semi-circular C-shaped portion further comprises a first medial end closer to the diaphragm and a second lateral end farther from the diaphragm; and
the semi-cylindrical portion further comprises an elongated groove with a uniform diameter.

6. The timing device of claim 5, wherein:
the first medial end of the semi-circular C-shaped portion of the piston stop limits a range of motion of the connecting rod in the counterclockwise direction; and
the second lateral end of the semi-circular C-shaped portion of the piston stop limits a range of motion of the connecting rod in the clockwise direction.

7. The timing device of claim 1, wherein:
the diaphragm further comprises an inner portion and an outer portion;
a gasket is provided on the inner portion;
a washer is provided on the outer portion; and
the piston rod is connected to the diaphragm by inserting a threaded portion of a hex shaped medial end of the piston rod through the washer, the diaphragm, and the gasket, and fastening it to a securing nut on the inner side of the diaphragm.

8. The timing device of claim 1, further comprising a torsion spring and wherein:
the valve assembly further comprises a flywheel and a valve plate; and
the torsion spring connects the flywheel of the valve assembly to the upper free end of the connecting rod, such that the torsion spring causes simultaneous sideways movement of the piston rod and rotational movement of the valve assembly.

9. A timing device for an intermittent vacuum regulator, comprising:
a diaphragm assembly comprising a diaphragm housing, a return spring, and a diaphragm projecting at least partially out of the diaphragm housing;
a piston rod comprising a first end and a second end, wherein the first end is coupled to the diaphragm;
a connecting rod comprising an upper free end coupled to the second end of the piston rod and a lower fixed end coupled to a valve pin;
a crankpin configured to perpendicularly couple the second end of the piston rod to the upper free end of the connecting rod;
a valve assembly comprising a flywheel and a valve plate;
a torsion spring coupling the valve assembly to the connecting rod;
a piston stop comprising a semicircular C-shaped portion on its front side and a semi-cylindrical portion on its back side;
wherein the piston rod directly pushes and pulls the connecting rod, such that during an intermittent operation of the timing device, the upper free end of the connecting rod rotates about the valve pin but is being limited in a range of motion by the piston stop.

10. The timing device of claim 9, wherein:
the diaphragm housing further comprises a cover plate with a circular opening; and
the diaphragm further comprises an outer portion and an inner portion, wherein the inner portion has a larger diameter than the circular opening, the outer portion has a smaller diameter than the circular opening, and the inner portion is affixed to an inner circumference of the circular opening to provide a vacuum seal while the outer portion is substantially protruding out of the diaphragm housing.

11. The timing device of claim 9, wherein:
the piston stop further comprises a wall with a center hole dividing the semi-circular C-shaped portion and the semi-cylindrical portion;
the semi-circular C-shaped portion further comprises a first medial end closer to the diaphragm and a second lateral end farther from the diaphragm; and
the semi-cylindrical portion further comprises an elongated groove with a uniform diameter.

12. The timing device of claim 11, wherein:
the first medial end of the semi-circular C-shaped portion of the piston stop limits a range of motion of the connecting rod in the counterclockwise direction; and
the second lateral end of the semi-circular C-shaped portion of the piston stop limits a range of motion the connecting rod in the clockwise direction.

13. The timing device of claim 9, wherein the torsion spring further comprises:
a first loop coupled to a camshaft on the flywheel of the valve assembly; and
a second loop coupled to a crank on the connecting rod;
wherein the torsion spring facilitates simultaneous sideways movement of the piston rod, rotational movement of the connecting rod, and rotational movement of the valve assembly.

14. The timing device of claim 9, wherein the diaphragm is composed of a flexible material having a circular profile, and comprises an inner portion with a first diameter and an outer portion with a second diameter, wherein the first diameter is larger than the second diameter.

15. The timing device of claim 9, wherein:
the diaphragm further comprises an inner portion and an outer portion;
a gasket is provided on the inner portion;
a washer is provided on the outer portion; and
the piston rod is connected to the diaphragm by inserting a threaded portion of a hex shaped medial end of the piston rod through the washer, the diaphragm, and the gasket, and fastening it to a securing nut on the inner side of the diaphragm.

16. A method of timing an intermittent vacuum regulator, wherein the regulator comprises a timing device having a diaphragm housing enclosing a return spring, a diaphragm coupled to a piston rod, a connecting rod coupled to the piston rod, the method comprising:
actuating the piston rod to move sideways in the direction of the diaphragm housing;
pulling the connecting rod with the piston rod to move in the same direction toward the diaphragm housing to a first critical point;
rotating the flywheel and the valve plate as a unit; and
actuating the connecting rod to move in an opposite direction away from the diaphragm housing to a second critical point, thereby rotating the flywheel and the valve plate as a unit to their original positions.

17. The method of claim 16, wherein actuating the piston rod to move sideways in the direction of the diaphragm housing comprises applying vacuum pressure to gradually pull the diaphragm and the return spring in the direction of the diaphragm housing.

18. The method of claim 16, wherein pulling the connecting rod with the piston rod to move in the same direction to a first critical point comprises:
coupling the piston rod to a crank on a freely movable upper portion of the connecting rod; and
pulling the piston rod in the direction of the diaphragm housing until the resistance of the return spring is overcome.

19. The method of claim 16, wherein rotating the flywheel and the valve plate as a unit comprises:
coupling the crank on the upper portion of the connecting rod to a camshaft on the flywheel with a torsion spring, wherein the flywheel and the valve plate are connected together;
moving the connecting rod about the valve pin in one direction until the resistance of the torsion spring is overcome; and
rotating the flywheel and the valve plate together.

20. The method of claim 16, wherein actuating the connecting rod to move in an opposite direction to a second critical point, thereby rotating the flywheel and the valve plate as a unit to their original positions comprises gradually decompressing the return spring to its original state and actuating the piston rod to begin moving sideways in a direction away from the diaphragm housing.
